(19) United States
(12) Patent Application Publication
(10) Pub. No.: US 2006/0266302 A1
(43) Pub. Date: Nov. 30, 2006

(54) Post-surgical veterinary pillow and method for using same

(76) Inventor: Sheila Tunnell, Waldorf, MD (US)

Correspondence Address: PERKINS COIE LLP;PATENT-SEA, P.O. BOX 1247, SEATTLE, WA, 98111-1247, US

(21) Appl. No.: 10/560,958

(22) PCT Filed: Jun. 28, 2004
(86) PCT No.: PCT/US04/20754

§ 371 Date: May 26, 2006

Related U.S. Application Data
(60) Provisional application No. 60/483,659, filed on Jun. 30, 2003.

(51) Int. Cl. A01K 29/00

(52) U.S. Cl. 119/814; 119/28.5

(57) ABSTRACT

The present invention provides a degree of protection and comfort for animals emerging from post-operative and/or anesthetized states. The pillow is constructed so that it has a rounded hook shape with a shorter end that curls back towards the long end after the manufacturing process. The pillow is designed to be made of a material that is washable, sanitizable and appropriate for use in a veterinary setting. This is usually vinyl, but can be other plastics or polymers. The stuffing should be a synthetic material with a reasonable give and the invention may require vary degrees of give depending on the intended use.

### CROSS-REFERENCE TO RELATED DOCUMENTS

This application claims priority under 35 U.S.C. § 119(e) to U.S. Provisional Application 60/______, entitled POST-SURGICAL VETERINARY PILLOW, filed Jun. 27, 2003, which is hereby incorporated by reference for all purposes.

### BACKGROUND

Often, due to the fact that many animals are not given sedatives or pain medication after surgery, an animal may come out of anesthesia too quickly. Animals such as cats and dogs often go into a series of violent movements called a “death roll” in which they throw their bodies back and forth while the anesthesia is wearing off. These animals are in a delicate state because of the surgery so that some degree of protection is needed while the animal is being restrained. An animal is in a delicate state even when given pain medication or sedation.

One way to protect the animal is to simply restrain it. This often involves wrapping the animal up in heavy towels and being placed in a “safe” part of a cage. The cages are placed on a slant, so that fluids and wastes from the animal can drain out. However, the cages have no bumpers, so the animal can hurt itself even wrapped in blankets.

### SUMMARY

The present invention provides a degree of protection and comfort for animals emerging from post-operative and/or anesthetized states. The pillow is constructed so that it has a rounded hook shape with a shorter end that curls back towards the long end after the manufacturing process. The pillow is designed to be made of a material that is washable, sanitizable and appropriate for use in a veterinary setting. This is usually vinyl, but can be other plastics or polymers. The stuffing should be a synthetic material with a reasonable give and the invention may require vary degrees of give depending on the intended use.

The veterinary pillow is manufactured by first making a flat shell of a washable and sanitizable material, such as vinyl, which can be completed by attaching two halves by various methods. The filling process changes the shape of the pillow to include the inward bend of the second section, creating a pressure or restraining section helping to secure the animal during post operative recovery.

The invention includes a method for preventing injury to an animal in a post-surgical veterinary setting. The device used in the claimed method is a pillow with elongated straight section and a first curved section which is attached at the top of the straight section and rotating between 165 and 185 degrees. A second section is attached to the first curved section at a first end and has a second end that extends to at least a third of the distance of the elongated section and preferably half, but no more than two-thirds. The production process curves the second end of the second section making it at least 25 percent closer than the first end and usually creating a change in angle between 15 and 50 degrees, with 25 to 45 in a preferred embodiment. The invention includes placing the anesthetized animal such that the back of the animal is along the inner side of the elongated straight section and placing the head of the anesthetized animal such that it at least partially lies across the first curved section. The second section curves such that it creates at least a small amount of pressure on the torso of the anesthetized animal, protected the animal during awakening from anesthesia. Other positions may also be appropriate for various types of veterinary procedures, such as placing the animal with the paws straddling the long portion, or with the pressure point securing the hip area.

### BRIEF DESCRIPTION OF THE DRAWINGS

FIG. 1A is a top view of the veterinary pillow before production

FIG. 1B is a side view of the pillow post-production with the short end reaching back towards the long end.

FIG. 1C is a side view of the invention.

FIG. 1D is another view of the invention.

FIG. 2 illustrates the veterinary pillow being used in a post-surgical recovery for a small animal.

FIG. 3 illustrates a preferred embodiment of the invention for post-surgical recovery for a small animal.

FIG. 4 illustrates an alternate embodiment of the invention with the animal secured in a alternate position.

FIG. 5A illustrates a sample of the proportions of a first embodiment of the invention before beginning the filling process or a “shell.”

FIG. 5B is a side view of the dimensions of a sample first embodiment of the invention after filling.

FIG. 5C shows a top view of the dimensions of a sample first embodiment of the invention after filling.

FIG. 5D illustrates another top view for the dimensions of first embodiment of the invention after filling.

FIG. 6 shows an alternate embodiment of the invention with the animal placed in a different position.

### DETAILED DESCRIPTION

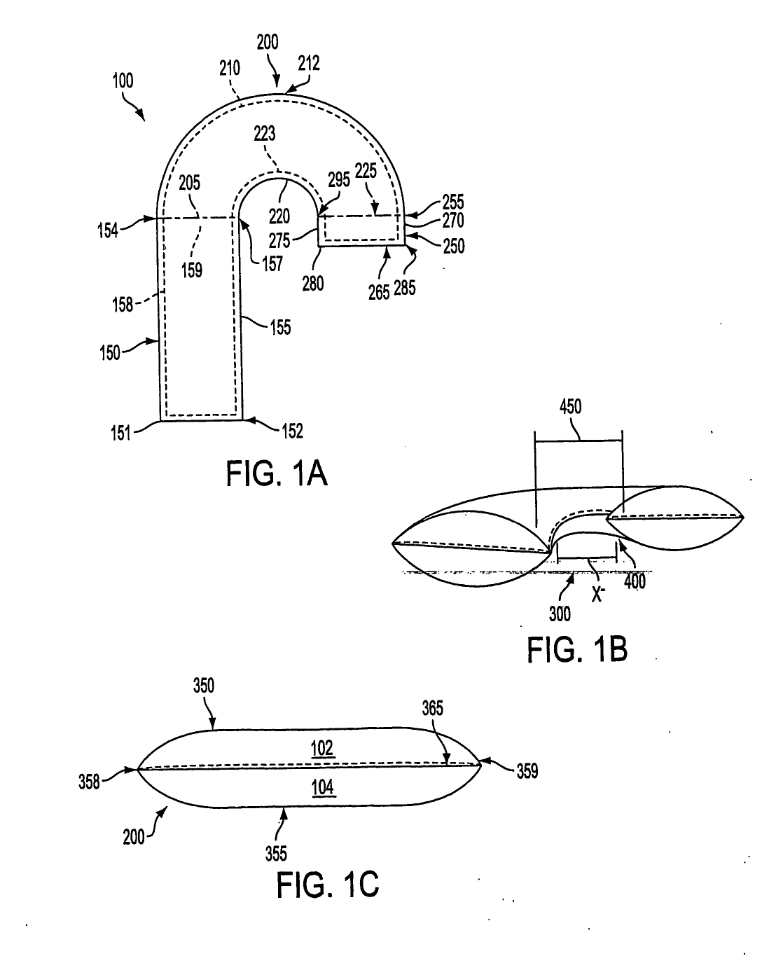

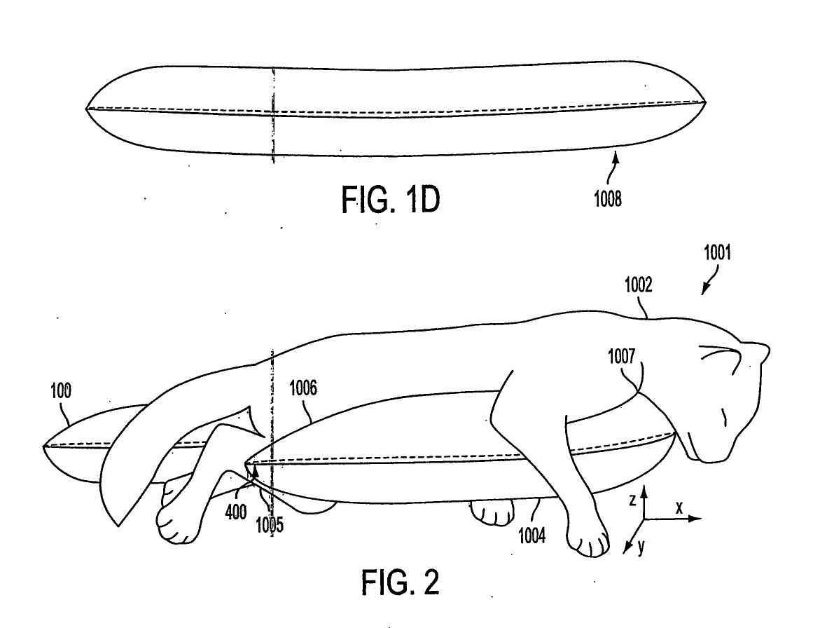

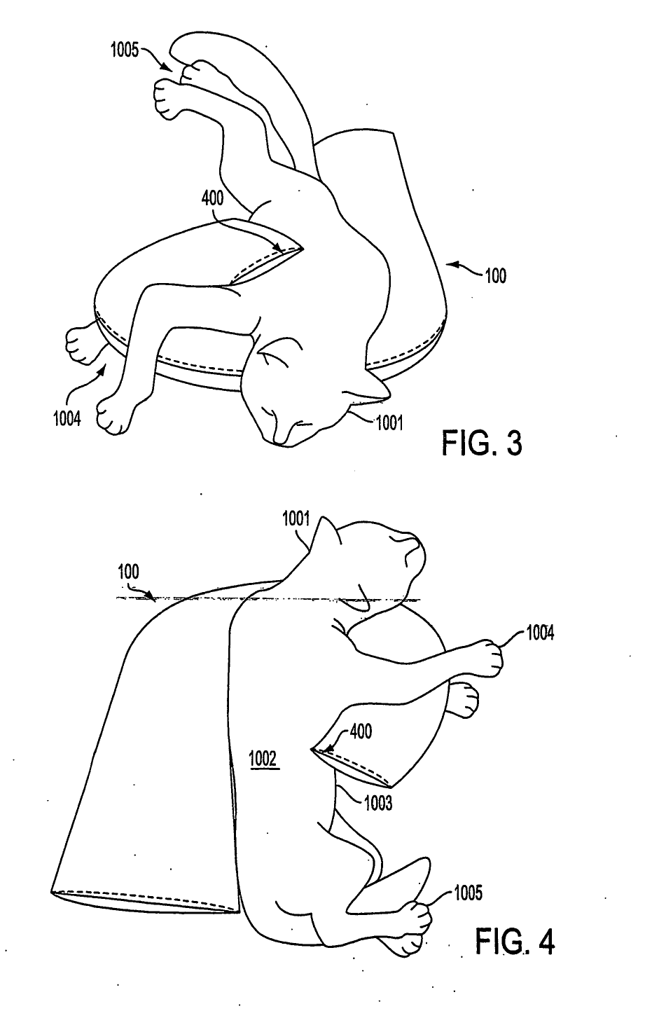

The drawings show that the veterinary pillow is a J-hook shaped pillow 100 with an arc that allows a short end to extend back to the long end. This curvature (FIG. 1B) can vary but helps to provide an additional degree of security in an animal recovering from surgery. The mild pressure on the area of the animal helps to secure the animal (FIGS. 3 & 4), but the shorted end still allows for full movement of the hind legs (FIGS. 2, 3, 4). As indicated the pillow appears to be highly useful for animals under 75 lbs. The use of this pillow for dogs or animals larger than 75 lbs is contemplated by the present invention and currently being tested.

The production process of the pillow allows for the advantages for use in a veterinary setting (or for appropriate uses in a convalescent setting with approved materials and construction for human medical use and agency approval). The material is selected from those appropriate for multiple cleanings and sterilization and is a vinyl in a preferred embodiment. Other polymers, polypro or polyethylene or plastics may be appropriate as long as they do not breakdown with standard disinfectants or cleaners used in the veterinary setting.

The top view cutout or pre-production shell (FIG. 1A) appears to be a J-shaped pillow 100, with a long straight portion 150, a short semi-straight short portion 250 and a curved portion 200 before production. The proportions of these sections are given for a sample first embodiment below in Table 1.2. Edges and points of relevance to the claimed invention are detailed in Table 1.1.

TABLE 1.1
Edges and points of Veterinary Pillow and indicator numbers

| FIG. | Num. | Pillow Section | Description |
|---|---|---|---|
| 1A | 151 | First Elongated 150 | Outside end point |
| 1A | 152 | First Elongated 150 | Inside base point |
| 1A | 154 | First Elongated 150 | Outside elongated tip |
| 1A | 155 | First Elongated 150 | Inside elongated edge |
| 1A | 157 | First Elongated 150 | Inside elongated tip |
| 1A | 158 | First Elongated 150 | Outside elongated edge |
| 1A | 159 | First Elongated 150 | Top elongated edge |
| 1A | 205 | Curved section 200 | Bottom edge |
| 1A | 210 | Curved section 200 | Outside edge |
| 1A | 220 | Curved section 200 | Inside arc |
| 1A | 225 | Curved section 200 | Ending edge |
| 1A | 212 | Curved section 200 | Top of outside arc |
| 1A | 223 | Curved section 200 | Top of inside arc |
| 1A | 255 | Second Semi Straight 250 | Top edge |
| 1A | 270 | Second Semi Straight 250 | Outside edge |
| 1A | 275 | Second Semi Straight 250 | Inside edge |
| 1A | 265 | Second Semi Straight 250 | Bottom edge |
| 1A | 280 | Second Semi Straight 250 | Inside (pressure) point |
| | | | (pre fill) |
| 1A | 285 | Second Semi Straight 250 | Outside point |
| 1A | 295 | Second Semi Straight 250 | Inside point of first end |
| 1C | 102 | All (curved 200 shown) | Top half |
| 1C | 104 | All (curved 200 shown) | Bottom half |
| 1C | 350 | All (curved 200 shown) | Top pillow edge |
| 1C | 358 | Curved section 200 | Widest base point |
| 1C | 359 | Curved section 200 | Widest outside point |
| 1C | 355 | All (curved 200 shown) | Bottom pillow edge |

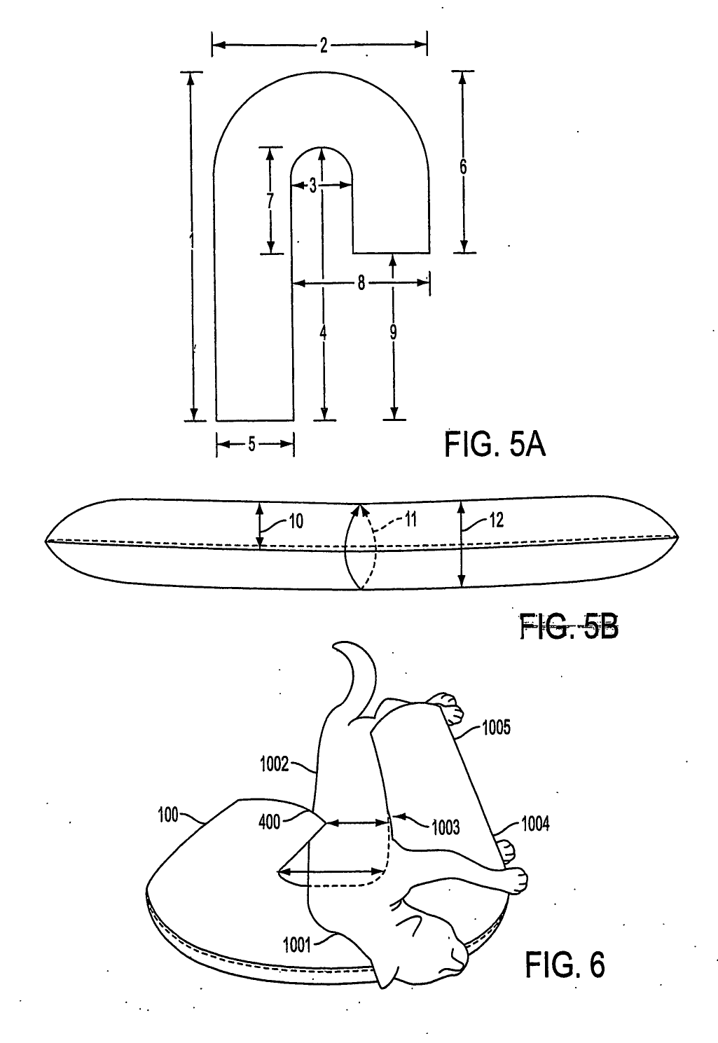

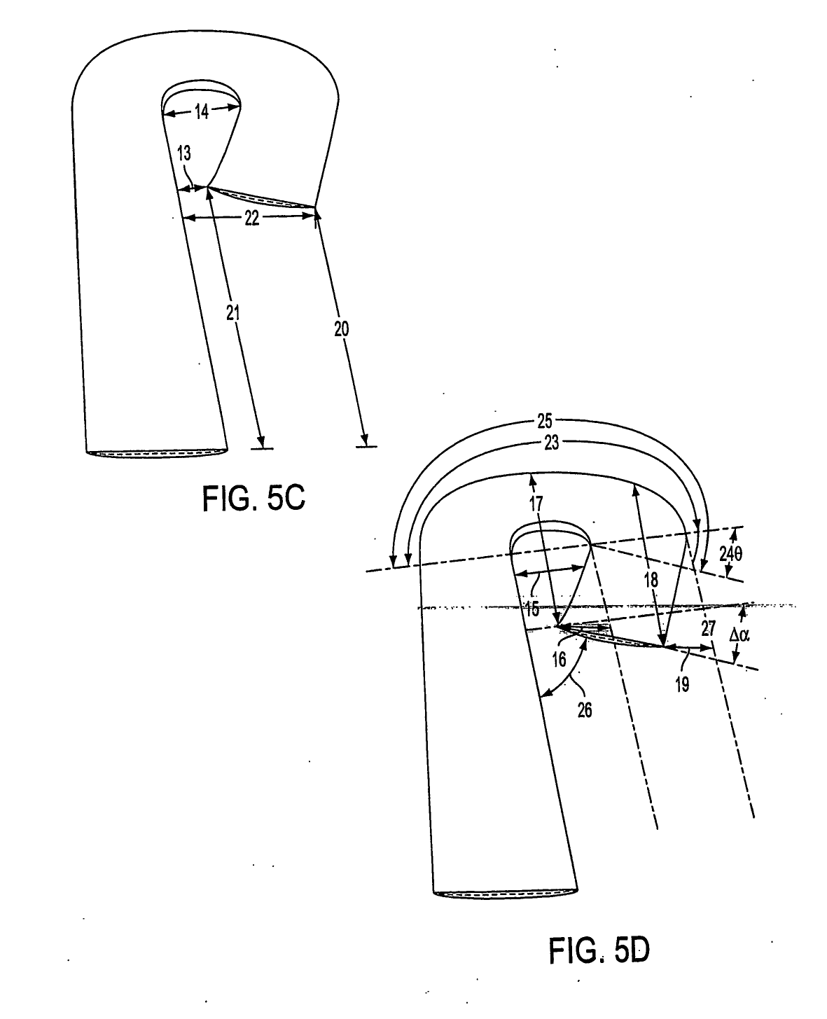

However, after being filled with a material appropriate for use in a veterinary setting, the short portion 250 curves back to the long portion 150. The curvature 300 can be adjusted as needed by different veterinarian suppliers and is dependent on some of the manufacturing materials for the pillow. The difference between the length in the long 150 and short ends is preferably 3:1 in a preferred embodiment, but other ratios may be needed for different animals. When the length of the curved portion 200 is added in, the ratio will be generally be 2:1 of long edge to short edge (see FIG. 5A, 1 compared to 6 or FIG. 5D 17 and 18), but no more than 3:2. The edge 265 of the short end 250 when curved towards the long end 150 creates a soft but secure pressure point 400 which helps protect the animal by use of the restraining zone 450.

FIG. 2 shows a small animal 1001 (a cat generally less than 25 lbs. is shown for illustrative purposes) in a position of the vet pillow 100 for one type of post surgical recovery. The cat 1001 is elevated on the pillow 100 facing downward. The throat area 1007 crosses the top 350 of the curved portion 200. This type of positioning may be preferred for surgeries where the animal 1001 must be in this position. A higher pillow (an embodiment that has a deeper width) may be appropriate for “taller” animals that require more elevation. The pressure point 400 in FIG. 2 is on the side of the animal in the hip area 1006 with the back of the animal 1002 facing upward. The front paws 1004 are facing downward and straddle the top of the curved portion 200, with a paw edge on the outside edge 210 and inside edge 220. The term “facing upward” is not meant to be restricted to a literal 90 degree angle, but rather should mean that the animal 1001, may be placed such that the normal 1008 extending from its back 1002 is facing between −45 to +45 from upward on the YZ plane.

FIG. 3 shows the invention in a preferred embodiment. FIGS. 3 and 4 show the animal in similar positions in which the cat 1001 is placed on its side (to one degree) with the pressure point 400 on the chest or front 1003 of the animal. The neck is draped over the top of the curved portion 200 and the paws straddle the short portion 250, which the long portions 150 provides the majority of the support to the back of the animal. In this embodiment the front paws 1004 are straddled over the outside 358 of curved portion 200. The back paws 1005 are left unsecured.

Of course, for abdominal surgery, if the pressure point 400 interferes with the surgical recovery, such as potentially chafing an injured area, then the animal can be turned to face the inside edge 155 of the long straight portion 150, while the pressure point 400 helps keep the animal secure from the other side. This embodiment is shown in FIG. 6 in which the animal's chest is placed along the inside edge 155 of the long side 150. The rear paws 1005 straddle the bottom portion of the long side 150 and the front paws 1004 straddle the area at the top 159 of the long portion 150 (bottom of the curved portion 205) with the back 1002 secured by pressure point 400.

FIGS. 5A-5D detail the proportions of a first embodiment of the invention contemplate for use in animals between 10 and 40 pounds, but can be used for animals out of that weight range to include the claimed 5 to 75 lbs. in a preferred embodiment. As can be appreciated by those skilled in the art, the proportions may vary as the size needed for particular animals varies.

TABLE 1.2
Pre and post production measurements for a sample
first embodiment. (Refer to FIGS. 5A-5D)

| | | | Pre- | Post- |
|---|---|---|---|---|
| | | | production | production |
| Measurement | | | (shell) | (pillow) |
| No. | | Description | (in.) | (in.) |
| 1. | (FIG. 5A) | Total length | 28 | 23 |
| 2. | (FIG. 5A) | Total Width | 15.5 | 13 |
| 3. | (FIG. 5A) | Init. gap width | 3.25 | N/A |
| 4. | (FIG. 5A) | Distance to inner arc | 21 | 19.25 |
| 5. | (FIG. 5A) | Section width | 6 | 4.25 |
| 6. | (FIG. 5A) | Init. return length | 14 | N/A |
| 7. | (FIG. 5A) | Init. inner return length | 8 | N/A |
| 8. | (FIG. 5A) | Inner edge to outer edge | 9.25 | N/A |
| 9. | (FIG. 5A) | Short end to long end | 13 | N/A |
| 10. | (FIG. 5B) | Seam to top | N/A | 2 |
| 11. | (FIG. 5B) | Circumference (around) | N/A | 12.5 |
| 12. | (FIG. 5B) | Height | N/A | 3.75 |
| 13. | (FIG. 5C) | Inner edge to pressure | N/A | 1 |
| | | point | | |
| 14. | (FIG. 5C) | Upper gap width | N/A | 3.75 |
| 15. | (FIG. 5D) | First section edge (at | N/A | 3 |
| | | tip) to edge | | |
| 16. | (FIG. 5D) | Δ (inward) | N/A | 3.5 |
| 17. | (FIG. 5D) | Pressure pt to top | N/A | 11.5 |
| 18. | (FIG. 5D) | Outer edge to arc | N/A | 13 |
| 19. | (FIG. 5D) | Δ (inward) outer edge | N/A | 3.75 |
| 20. | (FIG. 5C) | Outer edge to base | N/A | 10 |
| 21. | (FIG. 5C) | Pressure pt. to base | N/A | 12 |
| 22. | (FIG. 5C) | Inner edge to outer edge | N/A | 4.5 |
| 23. | (FIG. 5D) | Initial arc of curved | 165-195 | 185-240 |
| | | portion (theta 1) (Deg.) | | |
| 24. | (FIG. 5D) | Delta theta (Deg.) | N/A | 20-45 |
| 25. | (FIG. 5D) | Total arc (Deg.) | N/A | Varies. |
| 26. | (FIG. 5D) | Inward curvature (Deg.) | 85-95 (90) | >80 (>70) |
| 27. | (FIG. 5D) | Delta Gamma (Deg.) | N/A | 10-50 |

As indicated above, one of the embodiments of the claimed invention is the resulting inward loop-back shape of the veterinary pillow from the manufacturing process. As seen from Table 1.2, the pillow can be construction from a two or more sewn (or otherwise combined) pieces of material and would lie flat on a surface as seen in FIG. 5A. Thus, the measurements 1-9 would be two-dimensional. As shown in FIG. 5B, after filling, the dimensions of the pillow are three-dimensional and have depth (height) 10, 11, 12. In a preferred embodiment the pillow has a depth (12) of between 3 and 5 inches, but may adjusted depending on the needs of the veterinary practice.

FIGS. 5C and 5D show the post-production curvature of the pillow 100 and sample dimensions 13-27 related to the curvature. When the pillow 100 is “stuffed” or otherwise “filled” with appropriate fill for veterinary use. The second section 250 “curves” back towards the first elongated section 150 (measurement 16 or “delta”). This creates the pressure section 450 detailed above. The delta 16 can be adjusted for different contemplated uses by the manipulation of various factors as in the measurements 2, 3, 4, 6 and 8 (also 5) which are show in FIG. 5A. As can be appreciated by those skilled in the art, the use of different types of coverings or poly-fill may also result in changing the delta to the desired curvature (see 24, 25, 26) and the ratio of 24 to 26 (or more properly 24:27).

The material selected for the invention allows for the claimed veterinary use. Therefore, it is contemplated that the rigorous requirements for human medical use will not be required. However, some degree of sterilization will be required between uses. The claimed invention therefore will include materials that can be sterilized through chemical, heat, and/or radiation (ultraviolet) means. It is not contemplated that the cover material will have to withstand unusually harsh environmental conditions, such as extreme heat or cold. Resistance to liquids is expected. The filling of the invention is standard poly-fill in a first embodiment, but such poly-fill is generally firmer than that used in pillows for human use (medical). In a preferred embodiment, the shell is sewn in a 4-thread surge stitch which provides appropriate strength and durability. However, other attachment configurations may be appropriate for the claimed invention.

The fill can also be a combination of natural and synthetic fibers as well. The various properties of fill are generally known in that art and can be selected for the present invention depending on the needs of the end user. Companies, such as Fairfield® make different fill products. The Fairfield® fiberfill and other filling material literature are incorporated by reference insofar as informing the skilled artisan of options for particular variations of the claimed invention.

In another embodiment, the veterinary pillow is made of a single block of material and covered with a removable and disposable and absorbs some fluids. Thus the polymer body is not a “fill” and is manufactured to be more rigid than poly-fill. However, the manufacturing process must account for and produce the Delta curvature 24, 27 to create the pressure point 400. Thus, it is contemplated that a preferred embodiment of the invention will be manufactured by filling, which creates the configuration.

The descriptions above have been for illustrative purposes only, and the present invention includes variations that do not depart from the scope and spirit of the invention. Therefore, the public should respectfully take notice that the invention should be defined by the claims below and not limited to any embodiment detailed above.

Having described my invention above, I claim:

1. A method for preventing injury to an animal in a post-surgical veterinary setting, including the steps of:
providing a pillow with elongated straight section, a first curved section attached at the top of said straight section and rotating between 185 and 235 degrees, and an second section attached to said first curved section at a first end, said second section having a second end extending, wherein the inside point of said second end of said second section is at least 50 percent closer to the inside edge of the elongated section than the inside point of the second section at said first end;
placing said anesthetized animal such that the back of said animal is along the inner side of the elongated straight section of said pillow;
placing the head of the anesthetized animal such that it at least partially lies across the first curved section;
arranging said animal such that the second section creates at least a small amount of pressure on the torso or front of said anesthetized animal, whereby the animal is protected during awakening from anesthesia.

2. The method of claim 1, further including the step of straddling the front paws of said animal across said first curved portion.

3. The method as recited in claim 1, wherein said pillow is made of a washable and sanitizable material, such that said pillow may be used multiple times.

4. The method as recited in claim 3, further including the step of sanitizing said pillow after use.

5. The method as recited in claim 3, wherein said sanitizing step includes washing said pillow with a chemical.

6. The method as recited in claim 3, wherein said sanitizing step includes heat or radiation treatment of said pillow.

7. The method as recited in claim 1, wherein said pillow has a covering made of vinyl.

8. The method as recited in claim 1, wherein said pillow has a covering made of polypropylene,

9. The method as recited in claim 1, wherein said pillow is filled with poly-fill.

10. The method as recited in claim 1, wherein said animal is between 5 and 75 pounds.

11. The method as recited in claim 1, wherein said second section extends least a third and no more than two thirds of the total distance of the length of the pillow.

12. The method as recited in claim 1, wherein said arc is between 195 and 220 degrees.

13. The method as recited in claim 1, wherein said pillow is filled with a material including natural and synthetic fibers.

14. The method as recited in claim 1, wherein said pillow includes a core of compressed polyester.

15. A method for preventing injury to an animal in a post-surgical veterinary setting, including the steps of:
providing a pillow with elongated straight section, a first curved section attached at the top of said straight section and rotating between 185 and 235 degrees, and an second section attached to said first curved section at a first end, said second section having a second end extending towards said elongated section;
placing the anesthetized animal such that a first anatomical portion of said animal is along the inner side of the elongated straight section of said pillow;
placing the head of the anesthetized animal such that it at least partially lies across the first curved section;
wherein said second end of said second section creates at least a small amount of pressure on a second anatomical part of said anesthetized animal, whereby the animal is protected during awakening from anesthesia.

16. The method as recited in claim 15, wherein said first anatomical part is an injured part of said animal.

17. The method as recited in claim 15, wherein said second anatomical part is an injured part of said animal.

18. The method as recited in claim 15, wherein said second anatomic part is the side of said animal.

19. The method as recited in claim 18, wherein the back of said animal is facing at least partially upward.

20. A method for manufacturing a pillow for veterinary use, including the acts of:
creating a empty shell of a material appropriate for use a covering for a veterinary pillow, said empty shell having a long portion, a curved portion and a short portion, all of said portions configured in a hook shape, and;
filling said empty shell with a material appropriate for use in a veterinary pillow, such that said short portion extends back to said long portion and the arc of said curved portion is greater than 185 degrees.
